(19) United States
(12) Patent Application Publication
(10) Pub. No.: US 2006/0294554 A1
(43) Pub. Date: Dec. 28, 2006

(54) System and method for the control and distribution of content for television display

(75) Inventor: Phillip J. Hausman, Cary, NC (US)

Correspondence Address: COATS & BENNETT, PLLC, P O BOX 5, RALEIGH, NC, 27602, US

(73) Assignee: Telerent Leasing Corporation

(21) Appl. No.: 11/512,870

(22) Filed: Aug. 29, 2006

Related U.S. Application Data
(63) Continuation-in-part of application No. 10/694,969, filed on Oct. 28, 2003.

(51) Int. Cl. H04N 7/18; H04N 7/173; H04N 7/16

(52) U.S. Cl. 725/81; 725/100; 725/131; 725/139; 725/140

(57) ABSTRACT

A television provides a full range of content to be rendered to the user, while complying with strict hospital electrical isolation standards. An interface unit receives control inputs from a pillow speaker, translates the control inputs to appropriate commands, and outputs the commands to a television via a commercial grade control interface, and to a set top box. The interface unit receives an audio output signal from the television, galvanically isolates the audio signal, selectively amplifies the audio signal in response to control inputs from the pillow speaker, and outputs the volume-controlled, isolated audio signal to the pillow speaker. In this manner, the television can display any programming carried on a cable (a direct input to the television), as well as any audio-video content provided to the television from the set top box, which may include pay-per-view, instructional videos, interactive gaming, web browsing, and the like.

This application is a continuation-in-part of U.S. application Ser. No. 10/694,969, filed 28 Oct. 2003, the entirety of which is incorporated herein by reference.

### BACKGROUND

The present invention relates generally to the field of electronics and in particular to a system and method for selecting and controlling the content displayed on a television.

The modern television does far more than its original function of displaying broadcast television shows. While the television still performs that function, it additionally displays a wide variety of other content, including prerecorded audio/video content. The television provides a user interface for interactive services, such as accessing the World Wide Web. The provision of the varied content displayed on a television is often controlled and coordinated by an external unit having a variety of content source inputs, ubiquitously referred to as a “set top box.”

The ability of a television to display a variety of types of content has been exploited by the lodging and hospital industries. For example, a television in a hotel room, in addition to providing traditional broadcast and prerecorded audio/video content, may additionally offer interactive content, allowing a guest to view and order from a room service menu, or approve his or her bill for expedited checkout. This functionality is enabled by television manufacturers adding a sophisticated, “smart” interface and control module—referred to herein as a “commercial grade control interface”—to consumer grade televisions, which are then marketed as commercial grade (also known in the art as hospitality grade).

Hospitals additionally exploit the ability of a television to provide a variety of content. A television in a hospital room, in addition to displaying broadcast and prerecorded audio/video content, may additionally provide educational material, such as reviewing common medical procedures and providing care instructions. A hospital may also provide Internet access via a television and appropriate input devices, such as a wired or wireless keyboard with a mouse. Typically, basic functionality of the television—such as content selection, channel selection, volume control, and the like—is controlled by an existing, wired remote control device commonly known as a “pillow speaker.”

As its name implies, a pillow speaker is located physically on or near the patient's bed, and includes a speaker. Originally a nurse call and intercom device, the pillow speaker has evolved to include a variety of control inputs. In particular, a pillow speaker typically includes at least a numeric key pad, directional keys, and volume control keys, as well as a nurse call button. Hospitals impose stringent electrical conditions on any device that may contact a patient or sensitive electronics positioned around the patient's bed. In particular, they require strict galvanic isolation of any such device, to eliminate the possibility of stray current through ground loops.

Television manufacturers have addressed this need by a providing galvanic isolation circuit at the audio output, known as a pendent control jack, in addition to the commercial grade control interface, in television sets marketed as health care grade (also known in the art as hospital grade). While this allows a user to control the television from the pillow speaker while complying with hospital electrical regulations, it does not address how to control a set top box, which may provide, e.g., Web browsing functionality, educational programming, on-line access to patient records, video-on-demand, interactive video games, and similar video and audio-video content to the television.

### SUMMARY

A television system is disclosed herein that provides a full range of content to be rendered to the user, while complying with strict hospital electrical isolation standards. In one or more embodiments, an interface unit receives control inputs from a pillow speaker, translates the control inputs to appropriate commands, and outputs the commands to a television via a commercial grade control interface, and to a set top box. The interface unit receives an audio output signal from the television, galvanically isolates the audio signal, selectively amplifies the audio signal in response to control inputs from the pillow speaker, and outputs the volume-controlled, isolated audio signal to the pillow speaker. In this manner, the television can display any programming carried on a cable (a direct input to the television), as well as any audio-video content provided to the television from the set top box, with isolated audio provided to the pillow speaker.

In one embodiment, the present invention relates to a television system. The television system includes a television having a commercial grade control interface and having a cable input, a video input, an audio input, and an audio output. The television system also includes a set top box receiving audio-video content from a remote server, and providing a video signal to the television video input and an audio signal to the television audio input, the set top box including a data transfer interface. The television system further includes a cable providing a modulated signal to the television cable input, the signal carrying one or more channels of audio-video content. The television system additionally includes a remote control device including a speaker. Finally, the television system includes an interface unit connected to the set top box via the data transfer interface, connected to the television via the commercial grade control interface, receiving audio from the television via the audio output, and receiving commands from and outputting audio to the remote control device. The interface unit is operative to command the television to display video content from either the set top box or the cable in response to commands from the remote control device, and is further operative to output audio to the remote control device speaker.

In another embodiment, the present invention relates to a method of controlling, by an interface unit, the content displayed on a television. Control inputs are received from a user. The television is configured, via a commercial grade control interface, to display content from either a cable or a set top box, in response to the control inputs. The set top box is configured to conditionally output content to the television, in response to the control inputs. The set top box is periodically monitored for proper operation.

In yet another embodiment, the present invention relates to an interface unit for a television system. The interface unit includes an audio input; a pillow speaker interface receiving control inputs from a user and outputting a galvanically isolated audio signal; a television interface outputting commands to a commercial grade control interface; a set top box interface outputting commands to a set top box and receiving status information from the set top box; and a processor operative to generate commercial grade control interface commands and set top box commands in response to control inputs received at the pillow speaker interface.

### BRIEF DESCRIPTION OF DRAWINGS

FIG. 1 is a functional block diagram of a television control system according to one embodiment of the present invention.

FIG. 2 is a flow diagram depicting a method of controlling the content displayed on a television.

### DETAILED DESCRIPTION OF THE INVENTION

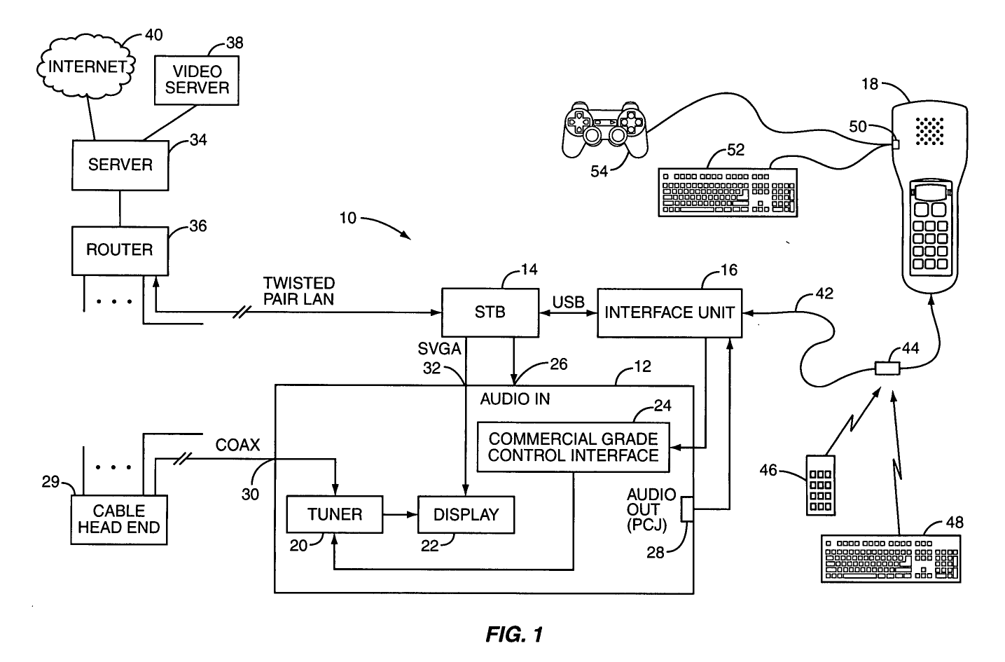

FIG. 1 depicts a television control system, indicated generally by the numeral 10, according to one embodiment of the present invention. The television control system 10, particularly suited for use in a hospital, comprises a consumer or health care grade television 12, set top box 14, interface unit 16, and a remote-control device having a speaker, such as the pillow speaker 18.

The television 12 includes a tuner 20 and display 22 as conventionally known, and a commercial grade control interface 24. The commercial grade control interface 24 is known in the art by various brand names, such as SmartPort™, MPI™, CCI™, and DCP™. The television 12 additionally includes various control and processing circuits as well known in the art, which are not depicted in FIG. 1 for clarity. In particular, the television 12 includes audio processing circuits that process and amplified audio signals from the tuner 20 or an external audio input port, and output a processed audio signal at an audio output port 28. In one embodiment, the audio output port 28 comprises a pendent control jack that outputs a galvanically isolated audio signal, a data signal, and a ground reference.

The television 12 receives a modulated signal comprising one or more audio-video channels from a conventional television programming distribution cable, output by a remotely-located cable head end 29, at cable input 30. The modulated cable signal is demodulated, and an audio-video channel extracted, by the tuner 20, under control of the commercial grade control interface 24. The tuner 20 provides a video signal to the display 22, and audio to the audio output port 28. The display 22, which may comprise a cathode ray tube (CRT), LCD display, plasma display, or the like, renders the video to be viewed by the patient.

The television 12 additionally receives a direct video signal, such as an SVGA signal, from the set top box 14 at a video input port 32. The display 22 may directly render the video signal. The set top box 14 additionally provides an audio signal at the audio input port 26. The set top box 14, which may for example comprise the Activity 300 unit available from Fujitsu/Siemens, and/or BCM Model STB1100, receives the video and audio-video content over a high-bandwidth local area network (LAN) from a remotely-located server 34, the output of which is distributed to a plurality of hospital rooms by a router 36.

The server 34 retrieves audio/video and interactive content from a variety of sources, including a video server 38 and computer network such as the Internet 40. The video server 34 may store and provide premium audio/video content, such as movies, recorded concerts, and the like. The video server 34 may additionally store and provide customized audio/video content, such as medical documentaries, educational programs, hospital introduction and orientation programs, emergency evacuation instructions, and the like. The server 34 may also retrieve a broad variety of audio/video and interactive content from the Internet 40, such as the World Wide Web.

The set top box 14 may additionally generate audio-video displays internally, such as introductory screens, menus, icons, and the like, as part of a television content selection and control software, such as the TigerNet™ software from Telerent Leasing Corporation of Raleigh, N.C.

The television control system 10 also includes the interface unit 16. The interface unit 16 includes a processor or microcontroller (not shown) and software operative to translate between various command and control formats. For example, the interface unit 16 receives inputs from the pillow speaker 18 and/or one or more other input devices 46, 48, 52, 54. These may be in the form of RC-5 codes for infrared communications. In response, the interface unit 16 controls the television 12 via the commercial grade control interface 24, the format of commands for which may vary among television 12 manufacturers. Finally, the interface unit 16 controls the set top box 14, via a data transfer link, such as a Universal Serial Bus (USB). The interface unit 16 processor may also run diagnostics and perform other overhead tasks.

The interface unit 16 additionally receives audio output from the audio out port 28, and provides the audio to the pillow speaker 18. In one embodiment, the interface unit 16 includes a galvanic isolation circuit (not shown) to isolate the audio signal from interface unit 16 or television system 10 electrical ground prior to providing it to the pillow speaker 18. This allows the television control system 10 of the present invention to utilize a commercial grade television 12 (which may not provide galvanic isolation of output audio), rather than the more specialized, and hence more expensive, health care grade television 12 (assuming the commercial grade television 12 otherwise complies with hospital standards).

The interface unit 16 and pillow speaker 18 are connected by a wired connection 42. In one embodiment, interposed in the wire 42 between the interface unit 16 and the pillow speaker detain is an optical input port 44. The optical input port 44 includes an optical receiver, such as a photo diode, and circuits to convert received optical signals to electrical signals, which are forwarded to the interface unit 16. This allows the television control system 10 to receive control inputs from a variety of wireless optical control devices, such as a conventional IR remote control 46, optical keyboard 48, or the like. The optical interface is typically infrared optical, and complies with the RC-5 codes for infrared communications. The infrared communication typically comprises an 880 nm wavelength infrared signal, modulated at 36 KHz. In addition, the pillow speaker 18 may include an accessory jack 50 that provides DC power to, and receives data input from, external accessory devices such as for example a wired keyboard 53 or game controller 54.

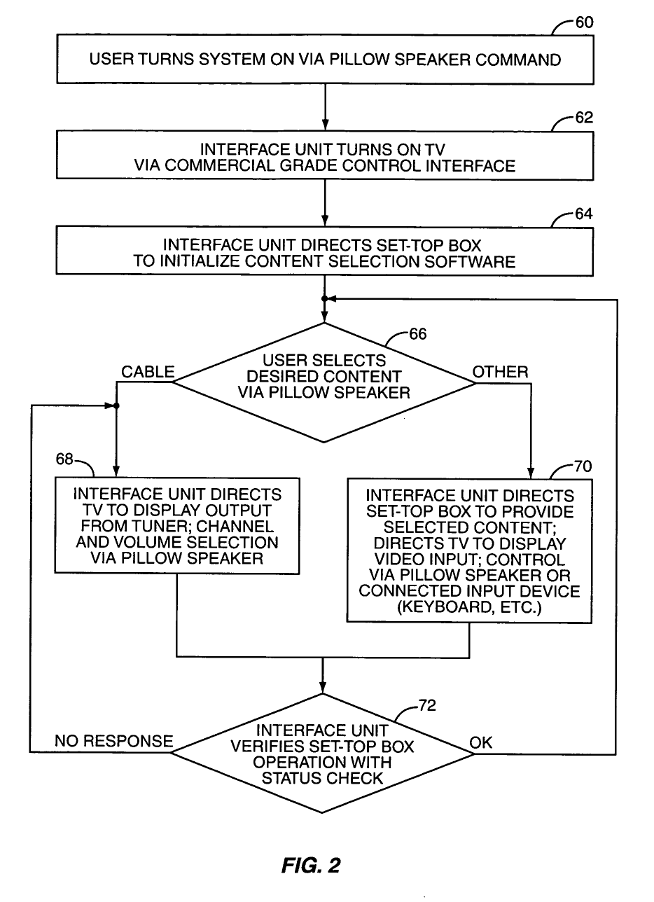

In operation, the interface unit 16 interprets user input from the pillow speaker 18, and controls other elements of the television control system 10 to display the user's desired content on the television 12, as depicted in the flowchart of FIG. 2. The user initially turns the system on via a command from the pillow speaker 18 (block 62). In response, the interface unit 16 turns on the television 12, and directs it to display output from the video input port 32 via commands to the commercial grade control interface 24 (block 62). The interface unit 16 additionally directs the set top box 14 to run content selection software, outputting a text or graphical menu to the video input port 32 of the television 12 (block 64).

The user navigates the displayed menu via keys on the pillow speaker 18 to select the desired content (block 66). Signals from the pillow speaker 18 are interpreted by the interface unit 16. If the user selected programming from among that provided by the cable, the interface unit 16 forwards appropriate commands to the commercial grade control interface 24 to display content from the tuner 20 on the display 22 (block 68). The interface unit 16 galvanically isolates audio output by the television 12 at the audio output port 28, selectively amplifies the audio, and provides it to the pillow speaker 18. The interface unit 16 adjusts the audio level directly, in response to volume up/down commands from the pillow speaker 18. The interface unit 16 interprets channel selection commands from the pillow speaker 18, and forwards appropriate commands to the commercial grade control interface 24 to change channels.

If the user selected other content (block 66)—such as pay-per-view, instructional video, or other audio-video content; Internet Web browsing; video game playing; or the like—the interface unit 16 forwards the appropriate commands to the set top box 14 to retrieve and display the desired content from the video server 38, Internet 40, or other source (block 70). The server 34 provides the requested content via the router 36 over a high-bandwidth channel, such as a Local Area Network, to the set top box 14. The set top box 14 outputs the video and, if present, audio to the television 12. The interface unit 16 controls the audio volume, and forwards commands to the set top box 14, in response to signals from the pillow speaker 18. Interactive signals, such as from the game controller 54 or keyboard 48, 52, are translated and forwarded to the set top box 14, for relay to the server 34.

Regardless of which content the user selects, in one embodiment the interface unit 16 periodically sends a status request command to the set top box 14, to verify the proper connection and operation of the set top box 14 (block 72). This is an ongoing background task, and if the set top box 14 responds, the interface unit 16 continues to monitor the pillow speaker 18 (or other input device 46, 48, 52, 54) for command signals and provides the selected content (block 66). If the interface unit 16 does not receive a response from the set top box 14 within a time-out period, the interface unit 16 will direct the commercial grade control interface 24 to display content from the cable via the tuner 20, and will respond to volume changes and channel selection signals from the pillow speaker 18 (block 68). In this case, if the set top box 14 had been retrieving content from the server 34, the server 34 will eventually become aware of no activity from the set top box 14, and may initiate a maintenance order or other corrective action.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A television system, comprising:
a television including a commercial grade control interface and having a cable input, a video input, an audio input, and an audio output;
a set top box receiving audio-video content from a remote server, and providing a video signal to the television video input and an audio signal to the television audio input, the set top box including a data transfer interface;
a cable providing a modulated signal to the television cable input, the signal carrying one or more channels of audio-video content;
a remote control device including a speaker; and
an interface unit connected to the set top box via the data transfer interface, connected to the television commercial grade control interface, receiving audio from the television via the audio output, and receiving commands from and outputting audio to the remote control device;
wherein the interface unit is operative to command the television to display video content from either the set top box or the cable in response to commands from the remote control device, and is further operative to output audio to the remote control device speaker.

2. The system of claim 1, wherein the interface unit further includes a galvanic isolator operative to isolate audio received from the television prior to outputting audio to the remote control device speaker.

3. The system of claim 1, wherein the galvanic isolator is optical.

4. The system of claim 1, wherein the interface unit receives commands from and outputs audio to the remote control device via a wired connection.

5. The system of claim 4, further comprising an optical input port interposed in the wired connection between the interface unit and the remote control device, the optical input port operative to codes corresponding to optical signals from one or more wireless devices.

6. The system of claim 5, wherein the interface unit is further operative to convert the codes output by the optical input port to corresponding control codes, and to output the control codes to the television commercial grade control interface.

7. A method of controlling, by an interface unit, the content displayed on a television, comprising:
receiving control inputs from a user;
configuring the television, via a commercial grade control interface, to display content from either a cable or a set top box, in response to the control inputs;
configuring the set top box to conditionally output content to the television, in response to the control inputs; and
periodically monitoring the set top box for proper operation.

8. The method of claim 7 further comprising, if the set top box does not respond to the monitoring, configuring the television, via the commercial grade control interface, to display content from either a cable

9. The method of claim 7 further comprising:
receiving an audio signal output from the television;
galvanically isolating the audio signal; and
outputting the isolated audio signal to a remote speaker.

10. The method of claim 9 further comprising selectively amplifying the audio signal in response to control inputs from the user, prior to outputting the isolated audio signal to the remote speaker.

11. The method of claim 10 wherein the remote speaker is a pillow speaker.

12. The method of claim 11 wherein control inputs from the user are generated by the pillow speaker.

13. An interface unit for a television system, comprising:
an audio input;
a pillow speaker interface receiving control inputs from a user and outputting a galvanically isolated audio signal;
a television interface outputting commands to a commercial grade control interface;
a set top box interface outputting commands to a set top box and receiving status information from the set top box; and
a processor operative to generate commercial grade control interface commands and set top box commands in response to control inputs received at the pillow speaker interface.

14. The interface unit of claim 13 further comprising a galvanic isolation circuit operative to isolate the audio signal output to the pillow speaker from the interface unit electrical ground.
